(19) United States
(12) Patent Application Publication
(10) Pub. No.: US 2002/0016724 A1
(43) Pub. Date: Feb. 7, 2002

(54) System and method for booking international multiple-stop tickets

(76) Inventors: Yue-Heng Yang, Taipei (TW); Chao-Chin Hsieh, Taipei (TW)

Correspondence Address: BIRCH STEWART KOLASCH & BIRCH, PO BOX 747, FALLS CHURCH, VA, 22040-0747, US

(21) Appl. No.: 09/897,125

(22) Filed: Jul. 3, 2001

(30) Foreign Application Priority Data
Jul. 28, 2000 (TW) 89115075

(51) Int. Cl. G06F 17/60

(52) U.S. Cl. 705/6

(57) ABSTRACT

The invention discloses a system and the corresponding method for booking international multiple-stop tickets. The system comprises at each node of an information network a global ticket reservation center which provides real-time information of global airlines and online booking and sale services, with at least one terminal device which provides customers an operating interface to book international tickets. The disclosed invention provides a method for at least one user who uses each terminal sale device distributed in the information network to accomplish the online operations of: inquiry and arrangement of flight schedules, inquiry of ticket prices, making reservations, canceling reservations, and changing the schedule for international tickets. Besides, the invention also provides travel plans that take the price and travel time as the prior consideration factors. The invention further includes an electronic monetary trading device to implement online ticket sale services.

### BACKGROUND OF THE INVENTION

1. Field of Invention

The present invention pertains to a system and the corresponding method for airline ticket reservations and sales and, more particularly, to a method for booking and trading international multiple-stop tickets over an information network.

2. Related Art

The traditional ticket reservations and sales models are:

1. Obtain relevant information about the planned travel through expert traveling agents, and commit the ticket reservations and sales to the travel agent.

2. Search for information relevant to the planned travel over the Internet, and complete the ticket reservations and sales through online reservation or by visiting the airlines company directly.

3. Inquire about information relevant to the planned travel from the airlines directly, and complete the ticket reservations and sales with the airline company directly.

The information relevant to the planned travel obtained accordingly may be a lot of paper documents or electronic information recorded and processed by personal computers. No matter what type of information it is, it must contain such immense and complicated information as flights, schedules, and fares. The traveler has to spend a huge amount of time and effort in comparison and searching to determine the airfare for each travel plan, whether the schedule is good for the planned travel, how to find out the most economical plan, and how to get the promotion. Other problems such as transfers during the trip, staying at certain places, and making reservations in advance have to be considered by the traveler during the trip too.

If the traveler decides to take a direct flight, all the above-mentioned problems can be solved easily. This is simpler for travelers who arrange trips on their own. However, when the trip is international or crosses several zones, it will be difficult for those travelers who have only documental information to make the plan.

For businesspeople who frequently travel among several countries, international multiple-stop trips are often considered. The flights among the stops may be connected (e.g. Taipei-New York-Los Angeles-Taipei) or unconnected (e.g. Taipei-New York, Washington, D.C.-Los Angeles-Taipei). The whole travel plan may include transfers, stays, flight cancellation, itinerary changes, or schedule changes. All these situations may cause the traveler to lose time or money simply due to improper interconnections.

It is well known to use computers to provide ticket reservations services to customers. For normal airline companies, they can build their own database and operation interface to immediately provide travelers relevant information such as flights, schedules, and airfares of the airlines. Through the airline company inquiry system, travelers can quickly obtain the services provided by the airline company. If a particular airline company can not satisfy the traveler's whole trip plan, the traveler has to request service from other airline companies to fulfill the rest of the trip plan. This is particularly true in international multiple-stop travels. This problem cannot be easily solve without the cooperation of different airline companies. It is another convenient way for travelers to resort to travel agents. Therefore, current computer-based ticket reservations or purchasing services are not satisfactory for customers having international multiple-stop trips.

There are other reservation and ticket purchasing technologies using computers. For example, the U.S. Pat. No. 5,897,620, “METHOD AND APPARATUS FOR THE SALE OF AIRLINE-SPECIFIED FLIGHT TICKETS”, discloses a technology to utilize computers to provide a more convenient, economical, and flexible ticket reservation and purchasing service for the traveler who is not sure when to start the trip within a certain period of time. It can provide travel information and reservation services for the part of the trip plan that the traveler is sure of. As long as the traveler replies with a definite traveling time later on, the technology can ensure the validity of the customer's reservation, a cheaper return ticket fare, and a flexible take-off time.

The U.S. Pat. No. 5,797,127, “METHOD, APPARATUS, AND PROGRAM FOR PRICING, SELLING, AND EXERCISING OPTIONS TO PURCHASE AIRLINE TICKETS,” discloses an apparatus, method, and program for determining a price of an option to purchase an airline ticket and for facilitating the sale and exercise of those options. A customer can lock in a specified airfare without tying up his money and without risking the loss of the ticket price if his travel plans change. The U.S. Pat. No. 5,570,283, “CORPORATE TRAVEL CONTROLLER,” discloses a method for saving corporate travel expenses.

The U.S. Pat. No. 5,237,499, “COMPUTER TRAVEL PLANNING SYSTEM”, discloses a system that can automatically arrange a travel plan for customers. The system comprises a database and a central processing unit (CPU). The CPU is in communication with the database and with a plurality of airline CRS systems. Through a venue file, a group member file, a travel policy file (containing information on preselected vendors of various travel services), and a city code file, the CPU is programmed to select an individual group member itinerary for the specific venue which includes specific airline flights, and if necessary, specific hotel accommodations and specific rental car services.

Although there are many computer-based services for ticket reservations and purchasing and providing tickets with less price as mentioned above, most of them are the services provided by the airlines companies. Therefore, the services are limited by the locality. Once a international multiple-stop ticket reservation is requested, the above-mentioned prior arts can not provide satisfactory services from how to arrange an optimal travel plan for customers, providing cheaper airfares until finishing reservations, and ticket trading.

### SUMMARY OF THE INVENTION

It is a primary object of the present invention to provide travelers services for international ticket reservations and purchases. Especially for international multiple-stop travels, the invention can provide good arrangements and ticket reservations.

It is another object of the invention to provide an online ticket reservation function for international multiple-stop travels.

It is another object of the invention to provide an online airfare inquiry function for international multiple-stop travels.

It is yet another object of the invention to provide travel plans pursuant to the economy or the fewest-stop principle.

Besides, the invention can provide reservation services for travels within a certain period of time according to the trip requirements given by the travelers and services to notify travelers to reconfirm the reservation if the plan satisfies the traveler's requests.

According to the disclosed reservation system for international multiple-stop tickets, the invention is a service system that can complete online ticket reservations through a wired or wireless information network. The system comprises a global ticket reservation and sales center and at least one terminal device distributed at nodes of the information network.

The global ticket reservation and sales center is a service system that can process global air ticket reservations and purchases. It can provide latest information about global airlines through the information network. It comprises currently available seats information for all airlines in the world and a system for processing ticket reservations and sales.

The terminal device is a reservation apparatus for travelers to make reservations in the global ticket reservation and sales center. It can be a personal computer (PC), a personal digital assistant (PDA), a notebook, a mobile phone, or any device that can connect to the information network and process data. The terminal device comprises: a trading interface (such as the combination of input and output devices like a monitor and a keyboard) for providing a traveler sufficient operation functions to make a reservation; a flight checking device for searching all flights that satisfy the traveler's travel plan according to its internal database or the latest information provided by the global ticket reservation and sales center, including reservation and purchase services; a ticket fare calculation device for calculating the final sales price for the flight service selected by the traveler (there may be international multiple-stop trips provided by different airlines companies) according to its internal database or the latest information provided by the global ticket reservation and sales center; and an online reservation device for completing a valid reservation request in the global ticket reservation and sales center according to the final flight service determined by the traveler.

The disclosed system further comprises a sales processing device for verifying the identity security information of the trading party, such as verifying whether the credit number or trading password of the traveler is valid and completing the ticket reservation sales procedure in the global ticket reservation and sales center.

Therefore, the ticket reservation system for international multiple-stop travels provided by the invention can find out a satisfactory travel plan for a traveler when he considers a plan that may contain multiple stops and complete, at the same time, the reservation request. The system is very convenient and safe for travelers.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a system functional block diagram of the invention;

FIG. 2 is a system functional block diagram according to another embodiment of the invention;

FIG. 3 shows a screen of the sales interface in an embodiment terminal device, displaying columns that allow travelers to enter travel plans;

FIG. 4 shows a screen of the sales interface in an embodiment terminal device, demonstrating that the system provides flight services that can satisfy traveler's plan;

FIG. 5 shows a screen of the sales interface in an embodiment terminal device, displaying a screen after the traveler selects a flight service provided by the system;

FIG. 6 shows the contents of a multiple-stop travel database;

FIG. 7 shows the contents of airfare-related information database;

FIG. 8 shows the contents of a reservation record database of the system;

FIG. 9 depicts a main flow chart of the disclosed method;

FIGS. 10A through 10C are flow charts showing detailed steps of the system;

FIGS. 11A through 11B are flow charts showing detailed steps of the system;

FIG. 12 is a flow chart showing detailed steps of the system;

FIG. 13 shows a screen of the sales interface in an embodiment terminal device when entering basic personal data of one or a plurality of travelers who complete reservations into the system; and

FIG. 14 shows a screen of the sales interface in an embodiment terminal device when doing online payments.

### DETAILED DESCRIPTION OF THE INVENTION

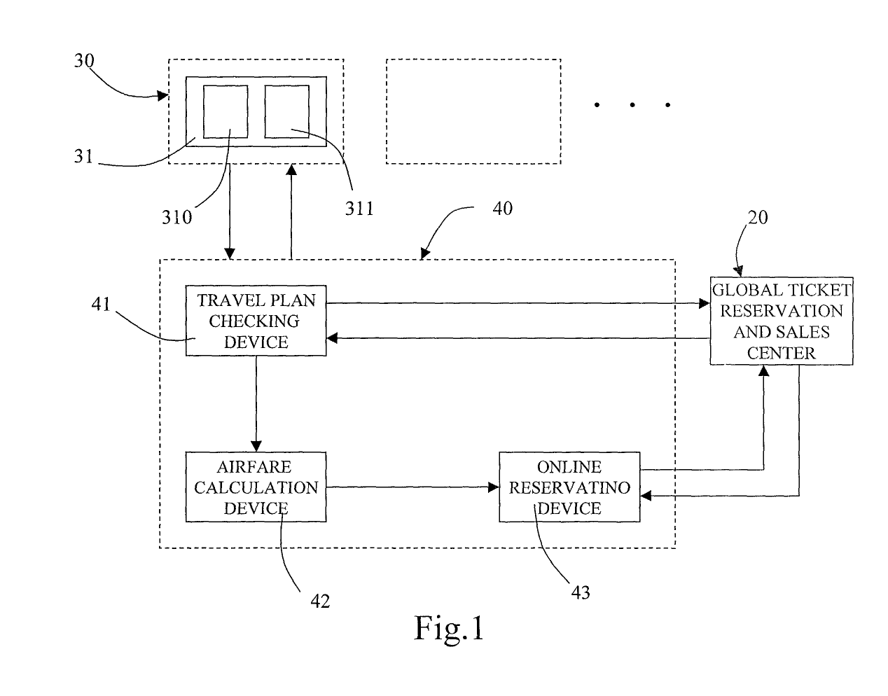

Please refer to FIG. 1, which is a system functional block diagram of the invention. The system comprises:

an information network 10 through wired or wireless communication, such as the World Wide Web or a local network;

a global ticket reservation and sales center 20 at a node of the information network 10 and being in communication with the information network 10 through a communications protocol (e.g. HTTP), which can provide the latest information regarding global airlines, accept reservation requests sent out by travelers through the information network 10 and ensure the validity of completed reservations;

a terminal device 30 at a node of the information network 10 and being in communication with the information network 10 through a communications protocol (e.g. HTTP), which can be composed of one or a plurality of units for serving more travelers in online ticket reservation, wherein the terminal device 30 can in fact be a personal computer (PC), a personal digital assistant (PDA), a notebook, a mobile phone and even devices that can access the information network 10 and process data, the terminal device 30 comprising a sales interface 31 for a traveler to enter the contents of his travel plan, generating a ticket reservation or purchasing request message to the global ticket reservation and sales center 20, and responding the processing result of the request message, such as a display 310 and an input device 311 that allows data input (e.g. a keyboard, mouse or optical pen);

an international multiple-stop ticket reservation unit 40 comprising:

a travel plan checking device 41, which is a program running in the terminal device 30 or the global ticket reservation and sales center 20 to check the validity of the request message; wherein by the validity of the request message more concretely means whether a satisfactory flight service meeting the traveler's requirements can be found according to the internal database or the latest information provided by the global ticket reservation and sales center 20, the travel plan checking device 41 can further find all flight services that satisfy the traveler's flight plan (there may be a plurality of different airline combinations) for the traveler to select, provide an optimal flight service, and respond through the sales interface 31 to the traveler no matter what result of the check is so that the traveler can complete online reservations and ticket purchases if the check result is valid or give up reservation operation otherwise;

an airfare calculation device 42, which is also a program running in the terminal device 30 or the global ticket reservation and sales center 20 for calculating the final sales price of the ticket reservation and purchasing according to the database or the latest airfare information provided by the global ticket reservation and sales center 20 after the traveler selects one of the many flight services provided by the flight checking device 41 and returning the final sales price to the traveler through the sales interface 31 so that the traveler can complete online reservations and ticket purchases if the check result is valid or give up reservation operation otherwise;

an online reservation device 43, implemented by a modem and a network communications software, which can not only download the latest information necessary for ticket reservation from the global ticket reservation and sales center 20 through the information network 10, but also sends out ticket reservation or purchase request messages to the global ticket reservation and sales center 20 and displays responses from the global ticket reservation and sales center 20, such as whether the request is valid or the reservation is successful, to the traveler through the sales interface 31.

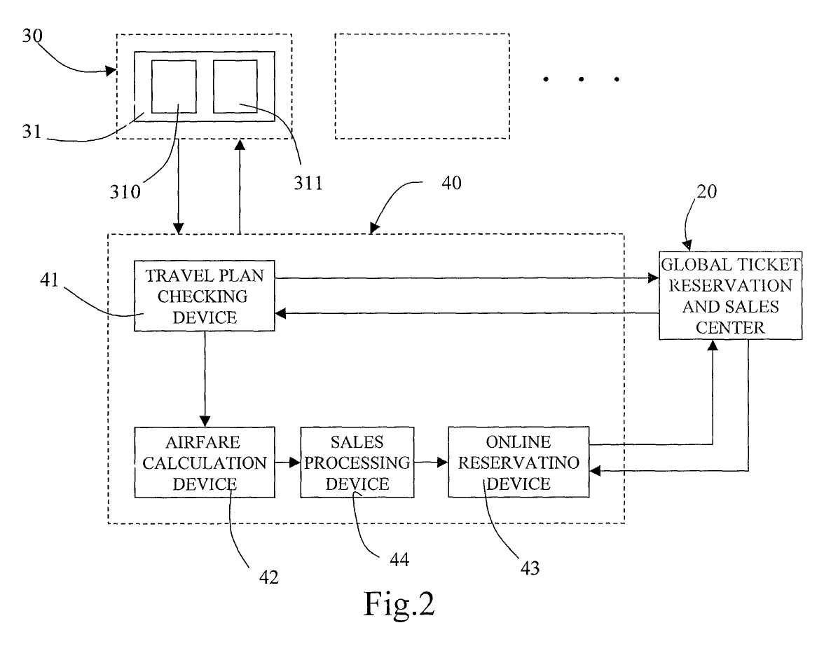

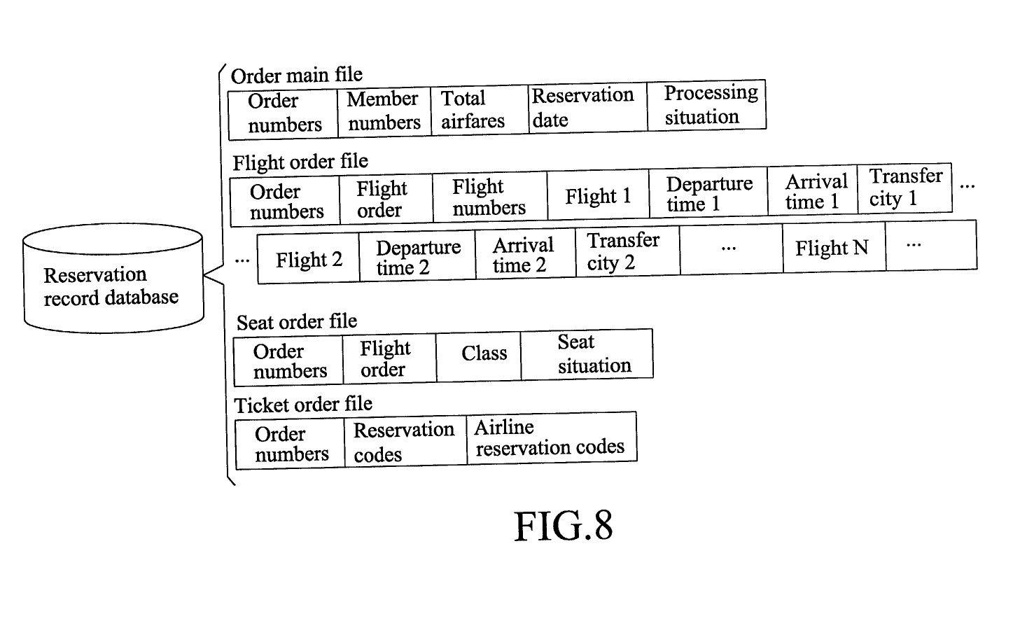

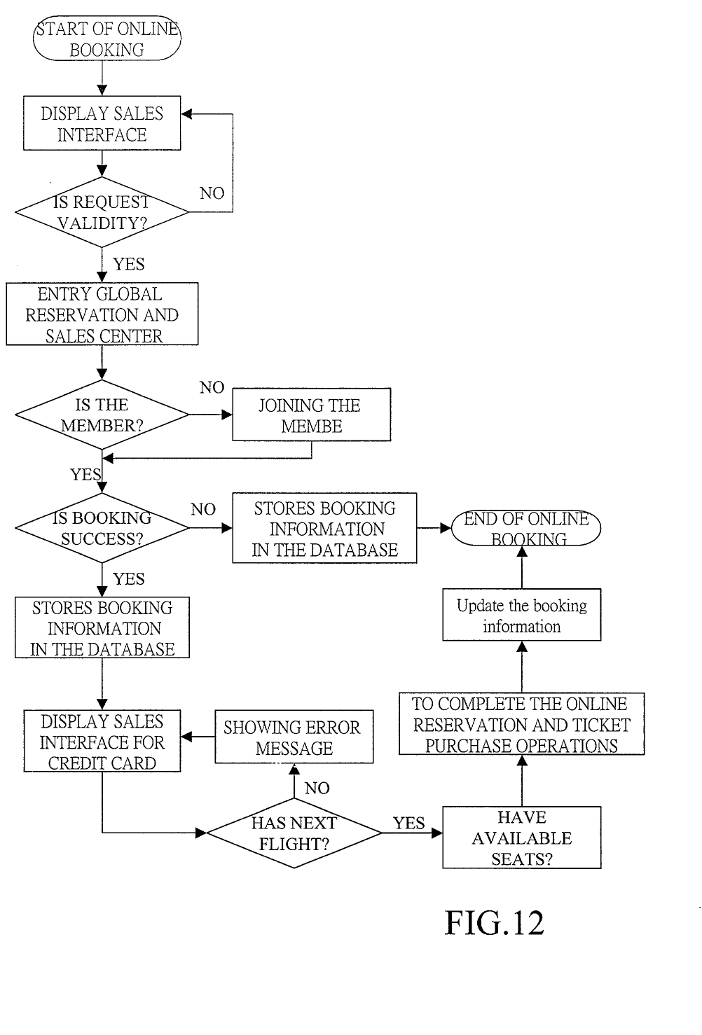

If a deposit or a fee is necessary to complete the ticket reservation and purchase during the reservation procedure, for the convenience of the traveler the international multiple-stop ticket reservation unit 40 of the present invention further comprises a sales processing device 44 (FIG. 2), which does not only verify the identity security data of the trading party but also completes the monetary trade for the global ticket reservation and sales center 20. The detailed trading flow is shown in FIG. 12. Since this trading mechanism is similar to that in electronic monetary trading technology in the prior art, only a preferred embodiment flow is described herein. In the trading procedure, the crucial point is that after the traveler completes the ticket reservation request through the electronic monetary trading method the global ticket reservation and sales center 20 will update the completed reservation data to the database therein and the same reservation data will be simultaneously stored in a reservation record database in the system for storing all ticket reservation records (FIG. 8, to be described in detail later).

The trading processing device 44 can be electronic online trading software installed in the terminal device 30, or can be an electronic monetary retrieving device (such as a credit machine) and a trading identity password entering device (such as a keyboard or a fingerprint recognition device) that is combined with a computer or operates independently.

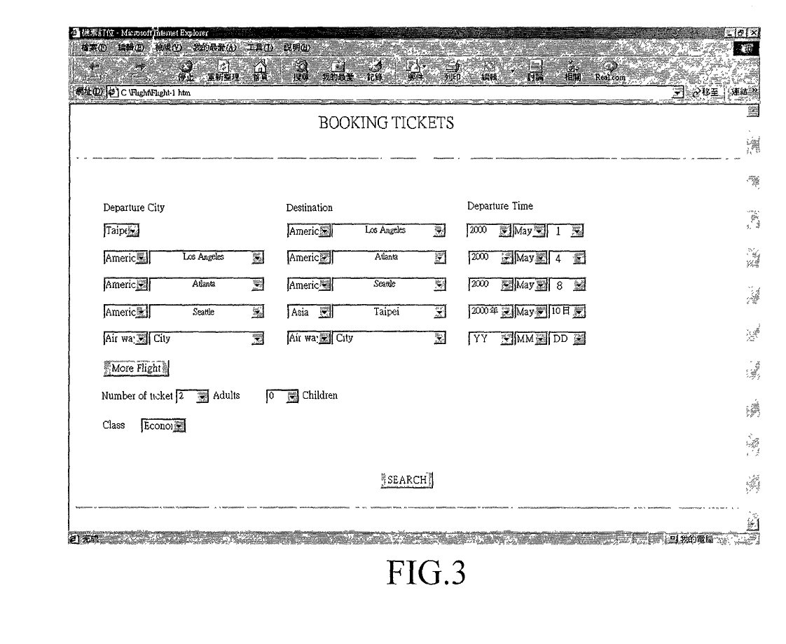

Please refer to FIG. 3, which shows a screen of the sales interface 31 in an embodiment terminal device 30, displaying columns that allow travelers to enter travel plans. As shown in the drawing, when the traveler looks for flight services that fit his travel plan through the disclosed system, the traveler needs to enter information of the departure city, time of departure, and venue of at least one flight to generate a ticket reservation or purchase request message. Of course the travel plan set by the traveler can be completed by one direct flight or be composed of a plurality of connecting flights. Therefore, an optimal flight service that can actually satisfy the traveler's travel plan will be provided for the traveler to select through the arrangement of the travel plan checking device 41 (particularly when a plurality of different flight services are available for the traveler).

On the other hand, if the travel plan set by the travel includes several flight courses, the traveler can readily enter all departure cities, departure times and venues of those flight courses into the system through the sales interface 31 in FIG. 3.

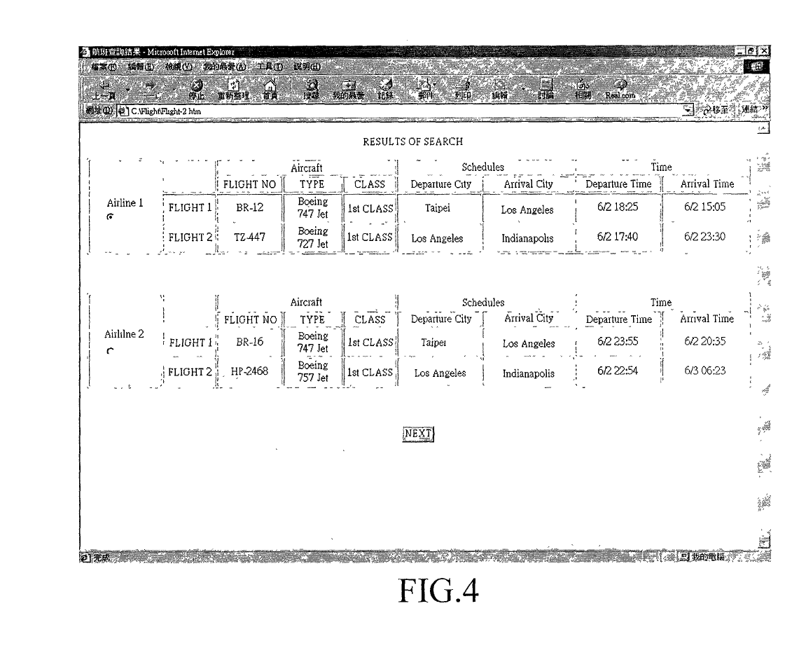

Once the above mentioned information is entered into the disclosed system, the traveler can select the flight inquiry button in the sales interface 31 to check if the flight services provided by currently available airlines have such a service that satisfies the travel plan. If there is, the travel plan checking device 41 will present one or a plurality of such satisfactory services to the traveler through the sales interface 31 for his further selections (FIG. 4).

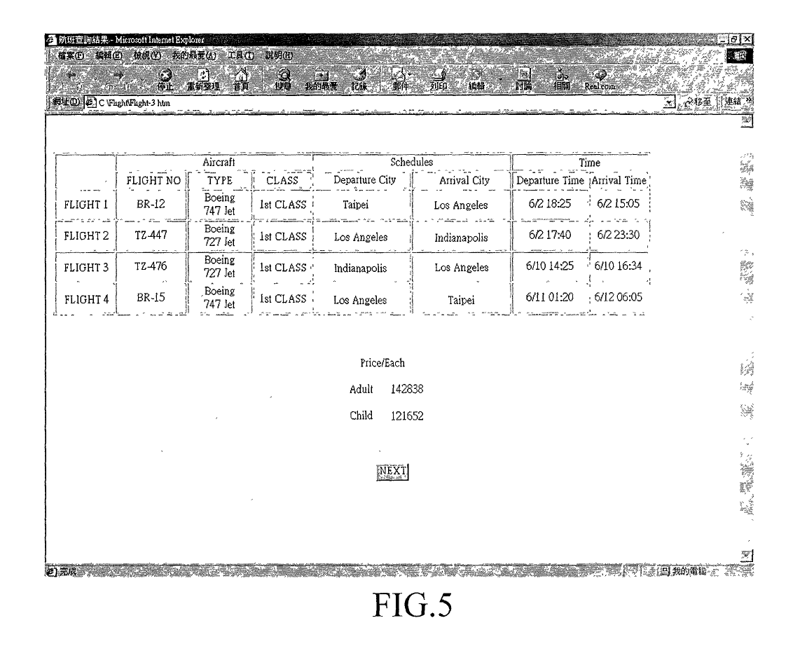

If the traveler wants to check the airfare at the same time, he needs to enter the number of tickets or the number of travelers and the classes in the sales interface 31 shown in FIG. 3. These reservation conditions help the travel plan checking device 41 search for flight services that meet the conditions and calculate the total airfare through the airfare calculation device 42 once the traveler selects a particular flight service. The total airfare is then displayed to the traveler through the sales interface 31 too (FIG. 5). If the traveler agrees upon this airfare, the sales interface 31 further confirms the ticket reservation or purchase.

When the travel plan checking device 41 checks whether the request message is valid, it needs the latest information from the database or the global ticket reservation and sales center 41. The information includes:

information of flight zone, such as Asian flights, American flights, European flights, etc;

information of departure and arrival cities of each flight;

information of time of departure and arrival of each flight; and

information of airlines, including

the names of airlines;

the flight codes; and

the classes of flights.

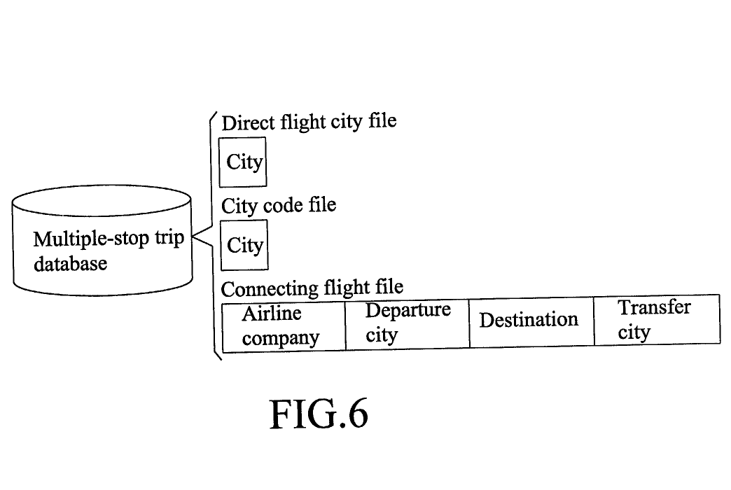

The above information will form a multiple-stop trip database in the database shown in FIG. 6. The database may include:

A direct flight city file: The file stores names of the direct flight cities so that when the one of the venues in the travel plan assigned by the traveler is included in the direct flight city the system will arrange this direct flight for the traveler as the first priority based upon the least transfer principle.

A city code file: The file stores all the cities that the flights of all airlines companies can reach. If the travel plan checking device 41 could not find in the city code file any departure or arrival city in the traveler's travel plan, it means that the service cannot fulfill his plan with currently available flight services throughout the world. The system will reply with an invalid response to the request message through the travel plan checking device. In a preferred embodiment of the invention, when the request message is invalid, the travel plan checking device 41 further provides to the traveler the following suggestions.

1. The system provides the flight that is closest to the traveler's plan, particularly when no flight can be found to fit the travel plan in currently available seats. The system finds out the flight services that can make the traveler's plan smoother and successful by suggesting the traveler to slightly modify his departure time. For example, if the traveler's original plan is Taipei-New York-Los Angeles-Taipei, but the travel plan checking device 41 could not find the flight from New York to Los Angeles at the times specified by the traveler in available airlines, the travel plan checking device 41 will find the next available flight (New York-Los Angeles) for the traveler to select.

2. The system will suggest the traveler to ask for the assistance from the airlines companies.

A connecting flight file: The file stores the information of airlines companies, departure cities, destination, and transfer cities. The file can:

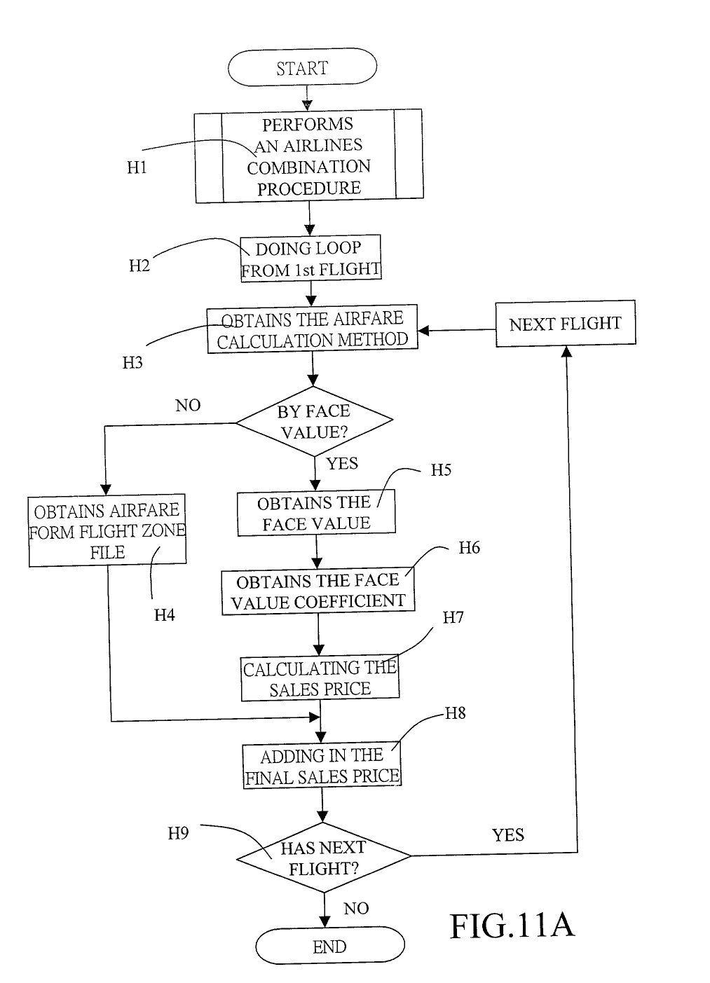

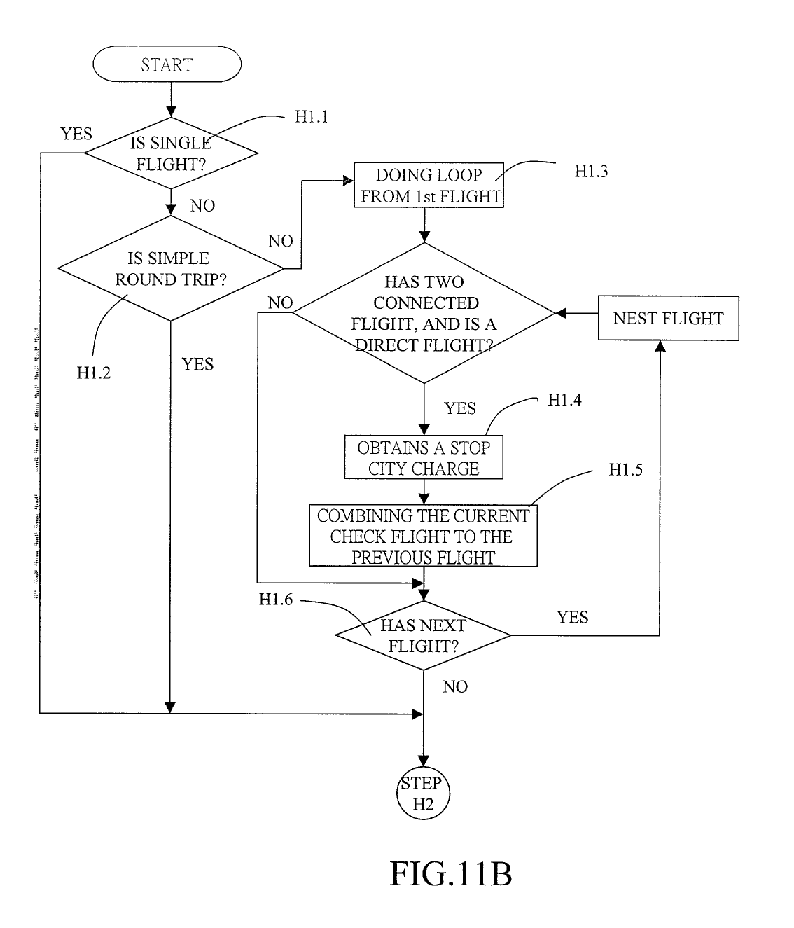

provide reference of whether flights should be combined (see FIG. 11B for the detailed procedure);

determine whether the travel plan contains stop cities and whether any additional fee should be charged to the traveler (see FIG. 11B for the detailed procedure).

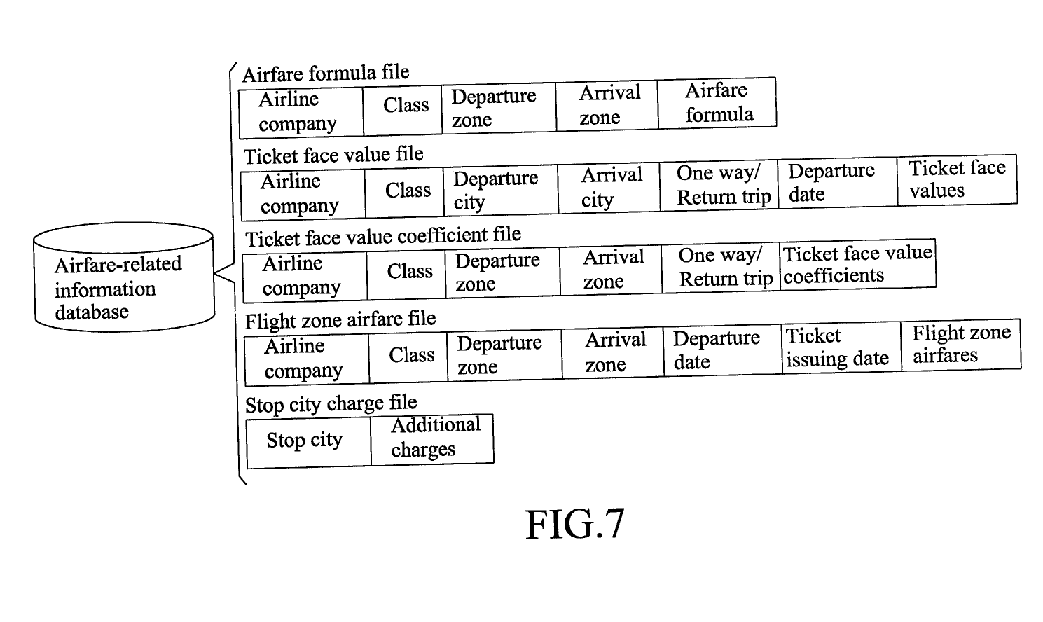

Please refer to FIG. 7, which shows the contents of airfare-related information database. The database comprises:

An airfare formula file: The file stores at least such data as the airlines companies, classes, departure zones, arrival zones, airfare formulas, etc, so that after the traveler agrees upon the selected flight service provided by the system, the airfare calculation device 42 can calculate the total fare accordingly.

A ticket face value file: The file stores at least such data as the airlines companies, classes, departure cities, arrival cities, one-way or round trip, departure time, ticket face values, etc, so that they can be related to the aforementioned ticket calculation formula file through the entry of airlines companies to provide the ticket face value needed in the ticket calculation formula.

A ticket face value coefficient file: The file stores at least such data as the airlines companies, classes, departure zones, arrival zones, one-way or round trip, ticket face value coefficients, etc., so that they can be related to the aforementioned ticket calculation formula file through the entry of airlines companies to provide the ticket face value coefficient needed in the ticket calculation formula.

A flight zone airfare file: The file stores at least such data as the airlines companies, classes, departure zones, arrival zones, departure date, ticket issuing date, flight zone airfares, etc., so that they can be related to the aforementioned ticket calculation formula file through the entry of airlines companies to provide the flight zone airfare needed in the ticket calculation formula.

A stop city charge file: The file stores at least such data as the stop cities, additional charges, etc., so that the additional charges can be included into the airfare if there are stop cities in the traveler's plan.

The terminal device 30 further includes a reservation record database for storing all ticket reservation records. As shown in FIG. 8, the reservation record database comprises:

An order main file: The file stores order numbers, member numbers, total airfares, reservation dates, processing situation, etc.

A flight order file: The file stores the complete ticket reservation record of each traveler, particularly the data of multiple-stop flights in detail. Such data are related to the order main file through the order number. The recorded contents may contain data of single flights or multiple-stop flights, for instance the order number, flight order, flight number, flight 1, departure time 1, arrival time 1, transfer city 1, flight 2, departure time 2, arrival time 2, transfer city 2, etc. of a multiple-stop travel plan.

A seat order file: The data such as the order numbers, flight orders, classes, and seat situation contained in this file are related to the order main file through the order number. In particular, the seat situation record messages such as “Reserved” and “In reservation.” “In reservation” means that the seat of one flight in the traveler's plan is not yet reserved due to some reason. The system will keep this reservation request for the traveler within a certain period of time and notify the traveler if the reservation is completed eventually through, for example, an assigned bulletin in the information network 10, by sending electronic mail to the traveler's electronic mail address, or sending a short message to the traveler's mobile communications device (such as a mobile phone or a pager) through a short message service.

A ticket order file: The file stores the order numbers, reservation codes, and airlines reservation codes for recording relevant information after the reservations are successful.

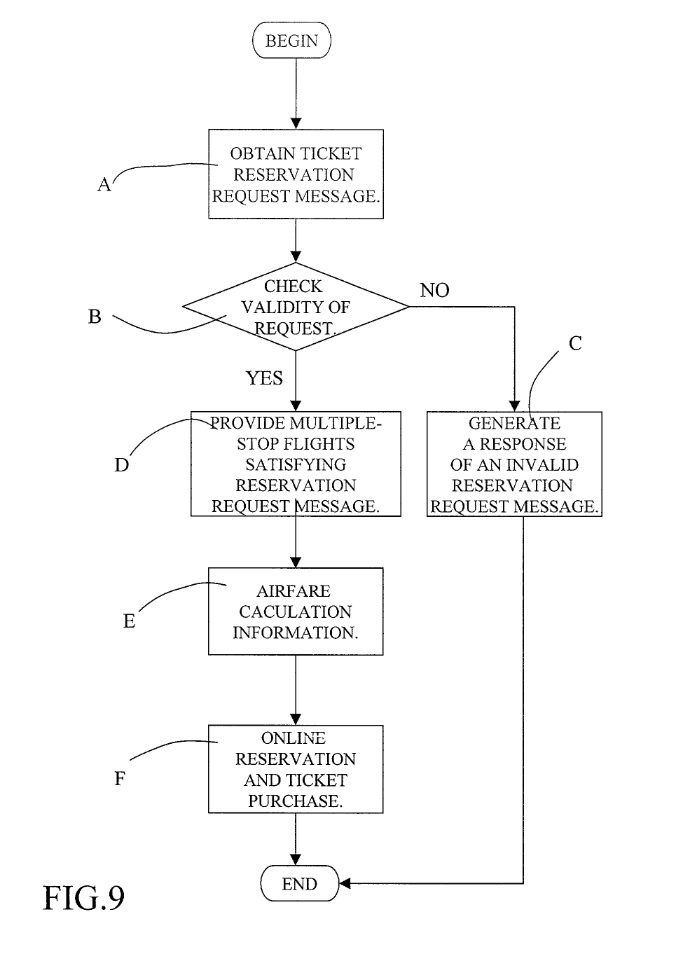

Please refer to FIG. 9 for a flow to implement the disclosed method. The method comprises the following steps:

A. Obtain a request message for the ticket reservation. This request message comprises information of at least a departure city, departure time, and travel plan to an arrival city, and is sent out by the traveler through the information network 10.

B. Check the validity of the ticket reservation request message. The validity of the request message is determined by finding in a database whether there is any global ticket reservation service that satisfies the request message.

C. Generate a response message indicating the invalidity of the ticket request message and end this ticket reservation flow when there is no flight service in the database that will not satisfy the travel plan.

D. Provide flight service information that conforms to the request message when the database has a flight service in the database that will satisfy the travel plan.

E. Calculate the airfare.

F. Perform online ticket reservation and purchasing. When the traveler selects a particular flight service, the system sends out a reservation request to the global ticket reservation and sales center 20 and completes the monetary trade by have the traveler pay the deposit or fee according to the rules.

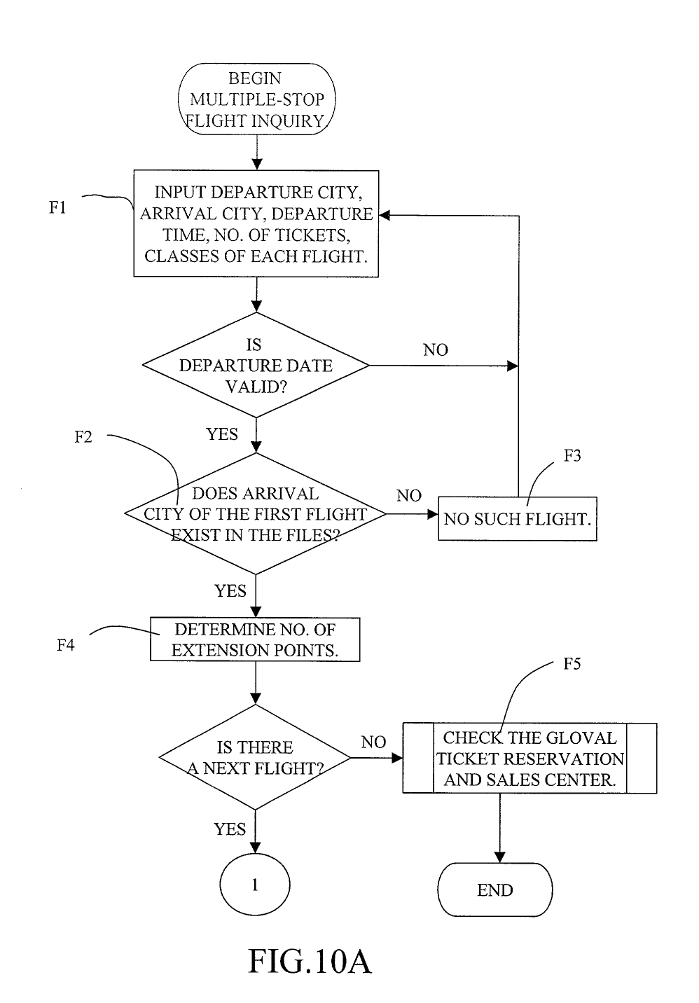

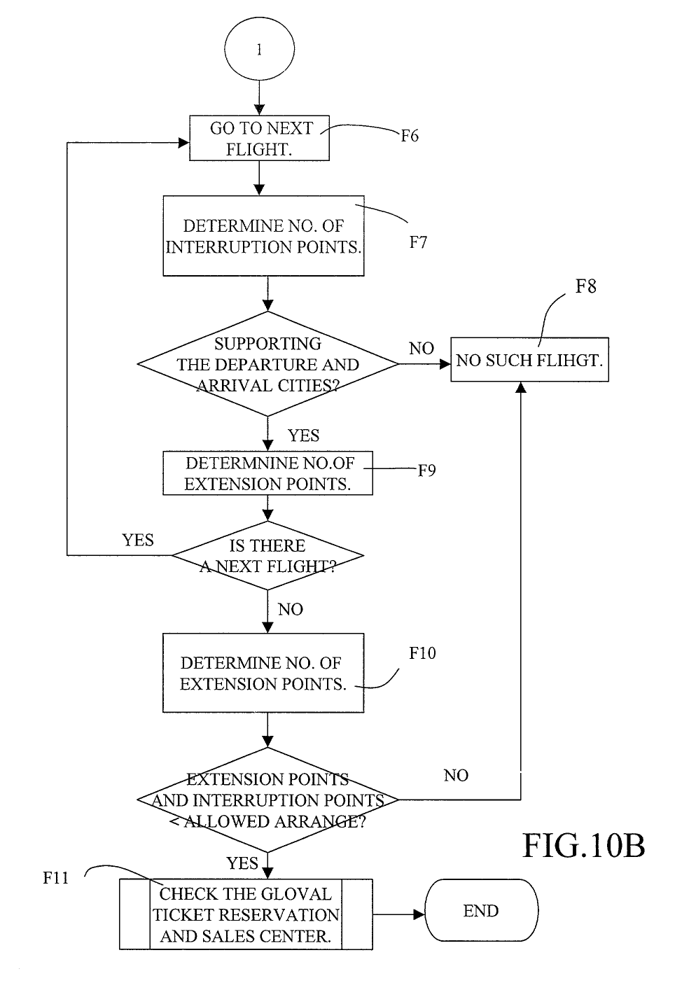

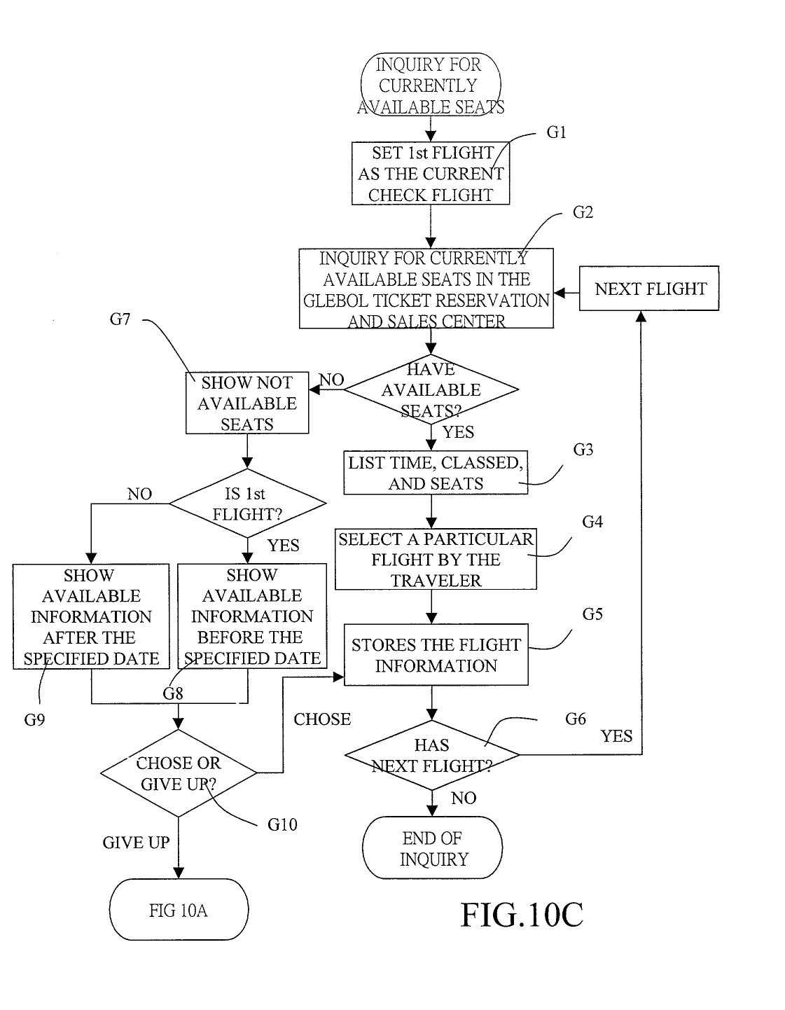

The detailed implementing steps of each step mentioned above can be understood later by referring the accompanying FIGS. 10A-10C.

As shown in FIG. 10A, the detailed steps for performing inquiry of multiple-stop flights comprise:

F1. The traveler enters data such as the departure city, arrival city, departure date, number of tickets, and classes for each flight in the travel plan.

F2. The system checks whether the arrival city of the first flight exists in the direct flight city file or the city code file when the departure date is valid and returns to step F1 if the date is invalid (for example, the departure date of the second flight is earlier than the arrival date of the first flight).

F3. When the arrival city of the first flight does not exist in the direct flight city file or the city code file, the system displays the message that the service does not include this flight through the sales interface 31 and returns to step F1. Otherwise, the system continues to step F4.

F4. The system calculates the number of extension points. The number is zero initially. In principle, if there is a next flight, the number of extension points is added by one.

F5. If the travel plan assigned by the traveler does not have a next flight, then the system performs the steps in FIG. 10C and finishes the operation of inquiring multiple-stop flights. Otherwise, the system goes to step F6.

F6. The system checks the information of the next flight.

F7. When the departure city of the current flight is not the same as the arrival city of the previous flight, the number of interruption points is added by one.

F8. When the departure and arrival cities of the current flight do not exist in the connecting flight file, the system displays the message that the service does not include this flight through the sales interface 31 and returns to step F1 for the traveler to inquire all over again.

F9. The system accumulates the number of extension points. When there is a next flight, the system returns back to step F6 or performs the next step otherwise.

F10. If the arrival city of the last flight is the departure city of the first flight (regarded as the return flight), then the number of extension points is subtracted by one.

F11. When the accumulated number of extension points is within an allowed range, the system performs the steps for inquiring the global ticket reservation and sales center shown in FIG. 10C or returns to step F8 otherwise.

The steps shown in FIG. 10C mainly demonstrate the inquiry procedure for currently available seats in the global ticket reservation and sales center 20 through the information network 10. The procedure comprises the following steps:

G1. The system initializes the current check flight by using a repeated loop. That is, the first flight is set as the current check flight in the beginning and each next flight is subject to the following checks.

G2. The system checks whether there is any available seat that satisfies all the conditions set as the current check flight in the global ticket reservation and sales center 20 according to the departure city, arrival city, departure date, etc of the current flight.

G3. When there is a seat that satisfies all the conditions set for the current check flight, the system displays the time, classes, and seats of all of them. Otherwise, the system performs step G7.

G4. The system obtains the information of a particular flight selected by the traveler.

G5. The system stores the flight information selected by the traveler in the reservation record database shown in FIG. 8, sets the next flight as the current check flight, and returns back to step G2.

G6. When there is a next flight, the next flight is set as the current check flight and the system returns back to step G2. Otherwise, the procedure of inquiring the global ticket reservation and sales center ends here.

G7. The system notifies the traveler that there is no available seat on the date specified by the traveler through the sales interface 31.

G8. When the current check flight is the first flight, the system displays the flight times, classes, etc. of available seats before or after the specified date.

G9. When the current check flight is not the first flight, the system displays the flight times, classes, etc. of available seats after the specified date.

G10. When the traveler selects a particular flight, the system performs step G5. Otherwise, the system considers that the traveler has given up and returns back to the multiple-stop flight inquiry procedure shown in FIG. 10A.

Please refer to FIGS. 11A and 11B, which are procedure flow charts showing detailed steps of calculating the airfare using the airfare calculation device 42 when the traveler selects the flights provided by the system according to the aforementioned steps. The procedure comprises the following steps.

H1. The system performs an airlines combination procedure for one or a plurality of flights, which combination procedure comprises the steps of (see FIG. 11B):

H1.1. going to step H2 when there is only one flight selected, or going to the next step otherwise;

H1.2. going to step H2 when there are only two flights selected and the arrival city of the second flight is the departure city of the first flight (i.e. a simple round trip), or going to the next step otherwise;

H1.3. performing a repeated loop starting from the first flight, setting a current check flight and performing the following checks for each flight;

H1.4. obtaining a stop city charge from the stop city charge file when the departure city of the current check flight is the arrival city of the previous flight and the departure city of the previous flight to the arrival city of the current check flight is a direct flight, or going to the next step otherwise;

H1.5. combining the current check flight to the previous flight;

H1.6. setting the next flight as the current check flight and returning back to step H1.4 when there is a next flight, or finishing the flight combination steps and going on to the next step.

H2. The system performs a repeated loop starting from the first flight by setting the first flight as the current check flight and performs the following checks for each flight.

H3. The system obtains the airfare calculation method from the airfare calculation formula file.

H4. The airfare obtained from the flight zone airfare file is the final price when the airfare calculation method is not using the ticket face value. The system then performs step H9.

H5. The airfare is obtained from the airfare face value file according to the airline, class, departure city, arrival city and departure date when the airfare calculation method is using the ticket face value.

H6. The system obtains the ticket face value coefficient from the ticket face value coefficient file according to the airline, class, departure zone and venue zone.

H7. The system calculates the sales price of this flight according to the formula: Final sales price=ticket face value×ticket face value coefficient.

H8. The sales price of this flight is added to the final sales price.

H9. If there is a next flight, the next flight is set as the current check flight and the system returns back to step H3. Otherwise, the system finishes the operation of calculating the airfare.

An example is used to demonstrate the technical contents of FIG. 11B hereinafter. Suppose a traveler selects the following flights from the flight services provided by the system for his travel plan:

First flight: Taipei-Hawaii;

Second flight: Hawaii-San Francisco;

Third flight: San Francisco-Washington, D.C.;

Fourth flight: Washington, D.C.-New York;

Fifth flight: New York-Taipei.

A set of direct flight data are recorded in the connecting flight file with the contents:

Airline company: China Airlines;

Departure city: Taipei;

Arrival city: San Francisco;

Transfer city: Hawaii.

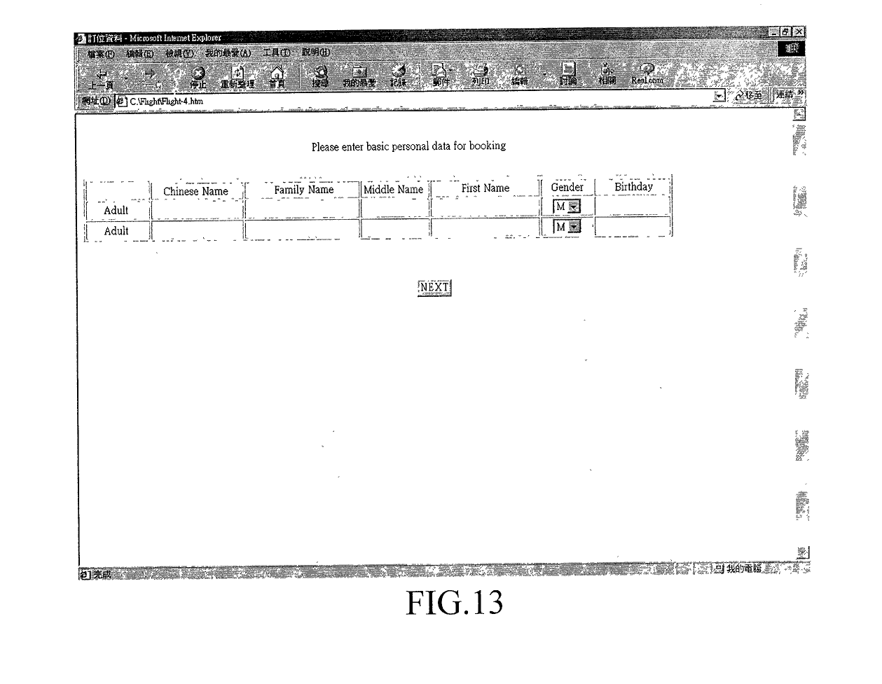

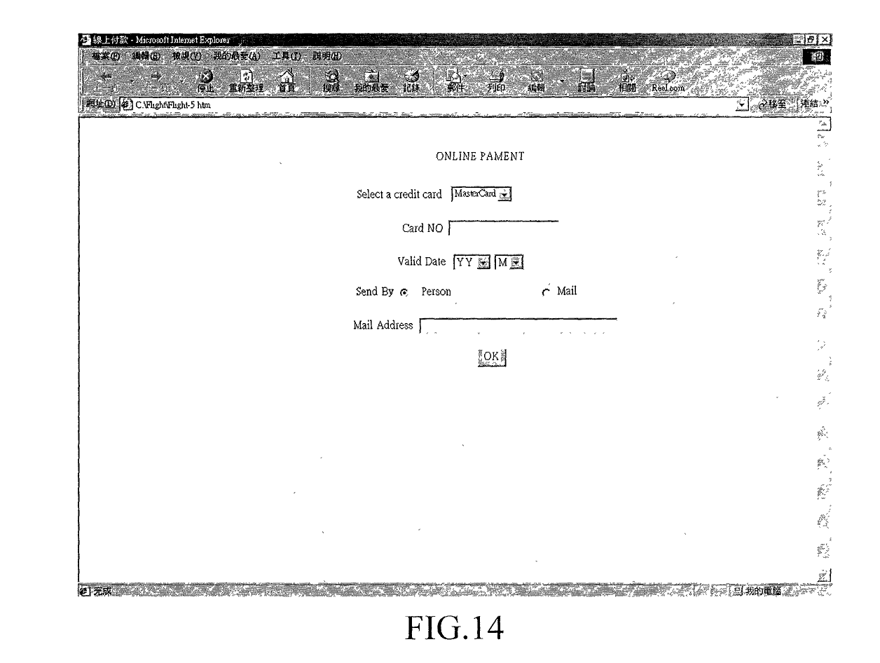

According to the procedure shown in FIG. 11B, the system checks that the departure city of the second flight (Hawaii) is the arrival city of the first flight and the departure city of the first flight (Taipei) to the arrival city of the second flight is recorded as a direct flight ill the connecting flight file with the transfer city being Hawaii. Therefore, the system will automatically combine the first flight with the second flight as one flight, the airfares of the two flights being thus combined into one airfare of a single flight. The short stay of the traveler in Hawaii in this direct flight will only slightly increase the airfare for staying over. Finally, please refer to FIGS. 12-14. Once the traveler selects any particular flight among all the flights provided by the system, he can perform operations of online reservation and ticket purchase with the global ticket reservation and sales center 20 by following the steps demonstrated in FIG. 12. This includes the screen, such as the one in FIG. 13, shown on the sales interface 31 of the terminal device for one or a plurality of travelers who complete reservation to enter their personal basic data. Through the online payment screen as in FIG. 14 shown on the sales interface 31 of the terminal device (e.g. the credit card data of the payer), the system will transmit the entered data to the global ticket reservation and sales center 20 through the sales processing device 44 and the information network 10 to complete the online reservation and ticket purchase operations.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An international airline ticket reservation system for providing at least one traveler who uses a terminal device distributed over the information network reservation services of international multiple-stop tickets, which system comprises:
a global ticket reservation and sales center, which provides real-time information of global airlines through the information network, accepts a reservation request made by the traveler through the information network and replies a valid response to the reservation request;
a sales interface, which allows the traveler to enter a request message relevant to the international reservation through the terminal device, and displays the resulting response to the request message;
an international multiple-stop reservation unit comprising:
a flight checking device, which checks whether the request message is valid and replies the check result to the sales interface;
an airfare calculation device, which calculates a final sales price for the air ticket according to the airfare information provided by the global ticket reservation and sales center and responds the final price to the sales interface; and
an online reservation, which sends out the request message to the global ticket reservation and sales center through the information network and responds the sales result to the sales interface.

2. The system according to claim 1, wherein the information provided by the global ticket reservation and sales center comprises reservation information for international multiple-stop tickets.

3. The system according to claim 1, wherein the global ticket reservation and sales center at least provides:
flight information including flight zones, departure and arrival cities, departure and arrival times and flight information;
ticket fare information including airfare calculation formulas, ticket face values, ticket face value coefficients, flight zone ticket information, stop city charge information, and promotion airfare information; and
sales information including airlines codes, reservation codes.

4. The system according to claim 3, wherein the flight information further comprises:
airlines companies;
airplane models; and
flight classes.

5. The system according to claim 1, wherein the request information relevant to international flight reservation entered by the traveler through the terminal device comprises: the departure city, departure time and arrival city of at least one flight.

6. The system according to claim 5, wherein at least the arrival city of one flight is the departure city of another flight in the multiple flights.

7. The system according to claim 1, wherein the request information relevant to international flight reservation entered by the traveler through the terminal device further comprises: the number and identities of travelers and the classes thereof.

8. The system according to claim 1, wherein the flight check device checks whether the request message is consistent with the global flight information provided by the global ticket reservation and sales center so as to determine whether any flight service can satisfy the request message.

9. The system according to claim 1, wherein the flight check device checks whether the request message is consistent with the information provided by the internal database so as to determine whether any flight service can satisfy the request message.

10. The system according to claim 9, wherein the database comprises:
a direct flight city file, which stores all arrival cities that the flight services can reach;
a city code file, which stores all departure cities that provide the flight services; and
a flight file, which stores information such as the airlines companies, departure cities, arrival cities and transfer cities.

11. The system according to claim 1, wherein the online reservation device is a network modem.

12. The system according to claim 1, wherein the terminal device is selected from the group comprising a personal computer, a personal digital assistant, a mobile phone, and a notebook that can establish communication with the information network.

13. The system according to claim 1 further comprising a sales processing device to verify the identity security data of the trading party and to complete the ticket reservation in the global ticket reservation and sales center.

14. The system according to claim 13, wherein the sales processing device comprises a password input device for trading party.

15. An international ticket reservation method implemented through an information network comprising:
obtaining a ticket reservation request message of a travel plan that comprises a departure city, a departure time, and an arrival city through the information network;
checking the validity of the reservation request message by finding in a database whether there is a flight service that can satisfy the request message so as to determine the validity of the request message;
generating a reservation denial message when there is no such flight service in the database that can satisfy the ticket reservation request message; and
providing the flight and airfare information of an international flight that satisfies the reservation request message in the database.

16. The method according to claim 15, wherein the ticket reservation request message is obtained by converting the reservation request conditions entered by the traveler at one terminal device distributed over the information network into the request message.

17. The method according to claim 15, wherein the request message comprises: the departure city, departure time, and arrival city of at least one flight.

18. The method according to claim 17, wherein the arrival city of at least one flight is the departure of another flight among the multiple flights in the travel plan.

19. The method according to claim 15, wherein the request message further comprises the number and identities of travelers and the classes thereof.

20. The method according to claim 15, wherein the international flight information contains information regarding a plurality of multiple-stop flights that satisfy the request message.

21. The method according to claim 20, wherein the information of the plurality of multiple-stop flights includes the flight information, departure city, departure time, arrival city, and arrival time of each flight.

22. The method according to claim 21, wherein the arrival city of at least one flight is the departure of another flight among the multiple flights in the travel plan.

23. The method according to claim 20, wherein the multiple-stop flight information is arranged according to the most economical airfare principle.

24. The method according to claim 20, wherein the multiple-stop flight information is arranged according to the least number of flights principle.

25. The method according to claim 15, wherein the database is obtained through an information network from a global ticket reservation and sales center connected to the information network.

26. The method according to claim 15, wherein the database comprises:
a direct flight city file, which stores all arrival cities that the flight services can reach;
a city code file, which stores all departure cities that provide the flight services; and
a flight file, which stores information such as the airlines companies, departure cities, arrival cities and transfer cities.

27. The system according to claim 15 further comprising a step of calculating a final price to obtain a final price according to the airfare information and airfare calculation formulas provided by the database.

28. The method according to claim 27 further comprising the calculation of stop city charges and promotion airfares.

29. The method according to claim 27, wherein the airfare information includes:
airfare calculation formulas;
ticket face values; and
ticket face value coefficients, which are used to determine the final sales price from the ticket face values.

30. The method according to claim 15 further comprising the step of keeping the ticket reservation request message when the request message contains a reservation message until the database has a service that satisfies the reservation request message, notifying the traveler through the information network in a wired or wireless method, and waiting until the traveler responds.

31. The method according to claim 15 further comprising the step of online purchase of an international airline ticket through the information network, which step includes security verification of the traveler's identity and electronic monetary trading.

32. The method according to claim 15 further comprising the step of providing a suggestion to the traveler when the request message is invalid, the suggestion being providing the closet flights to the traveler's original plan and slightly modifying the departure time of his plan so that the traveler's plan can be completed thereby.

33. The method according to claim 32, wherein the suggestion further comprises suggesting the traveler to contact airlines companies to ask for their assistance.
